(19) United States
(12) Patent Application Publication
(10) Pub. No.: US 2025/0386802 A1
(43) Pub. Date: Dec. 25, 2025

(54) ELECTRONIC ANIMAL CONTAINMENT SYSTEMS WITH USER DEFINED CONTAINMENT ZONES AND TURNAROUND DETECTION, AND RELATED METHODS

(71) Applicant: Sunward Electronics, Inc., Troy, NY (US)

(72) Inventors: Dean P. WATKINS, Delmar, NY (US); Andrew E. MCGIRR, Calgary (CA); Arnold D. GOULBOURNE, Calgary (CA); David R. JESSEE, Calgary (CA); Sojhal BROCHAL, Calgary (CA); Matthew E. MCGIRR, Calgary (CA)

(73) Assignee: Sunward Electronics, Inc., Troy, NY (US)

(21) Appl. No.: 19/310,902

(22) Filed: Aug. 26, 2025

Related U.S. Application Data
(63) Continuation-in-part of application No. PCT/US2024/017365, filed on Feb. 26, 2024.
(60) Provisional application No. 63/486,986, filed on Feb. 26, 2023.

(51) Int. Cl. A01K 15/02

(52) U.S. Cl. CPC A01K 15/023

(57) ABSTRACT

Electronic animal containment systems and related containment methods. The systems include a boundary wire bounding a containment area, a transmitter electrically coupled with the boundary wire, and a receiver configured to be carried by an animal. The transmitter generates a containment signal current in said boundary wire that produces a containment signal in the magnetic field emitted from the boundary wire. The receiver is configured to detect the containment signal, and selectively deliver at least one correction stimulus to the animal based in part on an extrapolated position of the receiver. The receiver extrapolates the position of the receiver in relation to the containment area by determining a digital received signal strength indication (RSSI) of the received signal strength of the containment signal and its relation to a plurality of user defined RSSI thresholds.

### CROSS REFERENCE TO RELATED APPLICATIONS

This application is a U.S. bypass continuation-in-part of International Patent Appl. No. PCT/US2024/017365 filed on Feb. 26, 2024 entitled Electronic Animal Containment Systems With User Defined Containment Zones, And Related Methods, which published as International Patent Pub. No. WO/2024/178437 on Aug. 29, 2024, which claims priority to U.S. Provisional Application No. 63/486,986 filed on Feb. 26, 2023 entitled Electronic Animal Containment Systems With User Defined Containment Zones, And Related Methods, which are hereby expressly incorporated herein by reference in their entireties.

### TECHNICAL FIELD

This application relates generally to electronic animal containment systems and related containment methods. More particularly, the application relates to electronic animal containment systems with a containment wire that provide corrections to an animal via a receiver worn by the animal based on received signal strength indications and user defined correction zones.

### BACKGROUND

Electronic animal containment systems are commonly used to keep an animal within a prescribed boundary. Typical electronic animal containment systems include a wire loop antenna that bounds a containment area, such as, for example, at least part of a pet owner's yard. The systems also include a transmitter in electrical connection with the wire loop that generates a signal carried by the wire loop such that the signal generates a magnetic field that is emitted about the wire. The systems further include a receiver that is carried by a pet and is responsive to the signal to the signal transmitted by way of the wire such that it issues warnings and/or corrections when the animal approaches the wire loop boundary. More specifically, when the pet approaches the wire, the signal strength at the receiver unit increases until it exceeds a predefined threshold, which occurs some distance from the wire. When the signal strength at the receiver unit exceeds the threshold, the receiver unit automatically/necessarily delivers a stimulus to the pet, discouraging the pet from leaving the pet owner's yard.

A drawback with these conventional electronic animal containment systems is that they only monitor received signal strength and compare it to fixed/static/predefined/preprogrammed thresholds that define one or more correction zone. These correction thresholds can thereby correspond to different physical distances from the wire from installation to installation, and are dependent upon the strength (e.g., amplitude) of the signal generated by the particular transmitter. For example, to decrease the physical distance from the wire of a particular predefined/fixed signal strength threshold, conventional pet containment systems decrease the strength of the signal transmitted from the wire such that the distance from the wire at which the signal strength at the receiver unit exceeds the threshold is decreased (thereby increasing the portion of the yard to which the pet has unfettered access). However, when that distance is decreased, the risk of the pet escaping the conventional pet containment system is increased. More specifically, the distance from the wire at which the signal strength at the receiver unit exceeds the threshold must be sufficiently large such that when the pet is running toward the wire, the receiver unit delivers a stimulus to the pet for a period of time sufficient to stop the pet's advancement toward the wire before the pet traverses the wire and moves the distance beyond the wire at which the signal strength at the receiver unit does not exceed the threshold. When this distance is not sufficiently large, the pet can easily, and even accidentally, move beyond the perimeter of the yard to the extent that the receiver unit does not deliver a stimulus to the pet. Additionally, when this occurs, the pet cannot reenter the yard without the receiver unit delivering a stimulus to the pet.

Still further, as these conventional electronic animal containment systems automatically/necessarily deliver a stimulus to the pet when the receiver (and thus the pet) exceeds the fixed/predefined threshold(s), the systems fail to take into account other factors that may affect whether or not the pet should be corrected. And as the threshold(s) are predefined or fixed, the user is unable to specifically tailor the threshold(s) to a specific distance(s) to suit a particular pet (via a particular receiver) and/or a particular yard/wire layout, modify the threshold(s)/distance(s) over time, or even simply set/modify the threshold(s)/distance(s) based on user preferences.

Further, typical current electronic animal confinement systems do not account for the direction of travel of the animal. Accordingly, depending on the location and direction of travel of the animal, the animal may receive correction or stimulus from an electronic animal confinement system after the animal has turned around and is re-entering or traveling towards the confinement area after traveling outside the confinement area, and/or is progressing through one or more confinement zones of the confinement area toward the safe zone thereof. Electronic animal confinement systems that account for the direction of travel of the animal and do not apply stimulus or correction to the animal when the animal is traveling into the confinement area and/or towards the safe zone would be beneficial and more humane.

Improved electronic animal containment systems and related methods that overcome one or more of the drawbacks of electronic animal containment systems that include a wire-delineated containment area are needed.

While certain aspects of conventional technologies have been discussed to facilitate disclosure of Applicant's inventions, the Applicant in no way disclaims these technical aspects, and it is contemplated that their inventions may encompass one or more conventional technical aspects.

In this disclosure, where an act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

Briefly, the present disclosure satisfies the need for improved electronic animal containment systems that include a wire-delineated containment area, and related methods that overcome one or more of the drawbacks of such prior electronic animal containment systems. In various embodiments, the electronic animal containment systems actively determine, and digitally identify, a current received signal strength indication (RSSI) of a containment signal received by a receiver (worn by a pet) of an electromagnetic field emitted by a containment wire. The electronic animal containment systems may use the RSSIs and custom user-defined RSSI correction thresholds to, in part, determine if the receiver should issue a correction to the pet according to a correction profile. The electronic animal containment systems and methods also comprise a system and method for establishing the user-defined RSSI correction thresholds based one or more physical location of the receiver as set by the user/administrator with respect to the containment/boundary wire. In some such embodiments, the systems and methods may utilize electromagnetic signals emitted via a user interface to initiate and effectuate the configuration/setting of the user-defined RSSI correction thresholds in the receiver.

The present disclosure may address one or more of the problems and deficiencies of the art discussed above. However, it is contemplated that the disclosure may prove useful in addressing other problems and deficiencies in a number of technical areas. Therefore, the claimed inventions should not necessarily be construed as limited to addressing any of the particular problems or deficiencies discussed herein.

In one aspect, the present discloses provides an electronic animal containment system comprising: a boundary wire bounding a containment area; a transmitter electrically coupled with said boundary wire, said transmitter generating a containment signal current in said boundary wire that produces a containment signal in the magnetic field emitted from the boundary wire; and a receiver unit configured to be carried by an animal, detect the containment signal, selectively deliver at least one electrical correction stimulus to the animal, and selectively deliver and at least one non-electrical correction stimulus to the animal. The receiver unit is configured to extrapolate the position of the receiver unit in relation to the containment area by determining a digital received signal strength indication (RSSI) of the received signal strength of the containment signal and its relation to a plurality of RSSI thresholds. The receiver unit selectively delivers the at least one electrical correction stimulus and/or the at least one non-electrical correction stimulus to the animal based in part on the extrapolated position of the receiver unit.

In some embodiments, the containment signal current is modulated. In some embodiments, at least one non-electrical correction stimulus to the animal comprises at least one a tone stimulus, at least one light stimulus, at least one vibration stimulus and at least one olfactory stimulus, or a combination thereof.

In some embodiments, the RSSI thresholds correspond to boundaries of differing containment zones extending differing distances from the boundary wire. In some embodiments, receiver is configured to deliver differing correction schemes of differing stimuluses when the receiver unit is positioned within the differing containment zones. In some embodiments, the receiver unit is configured to deliver a first correction scheme to the animal when the receiver unit is positioned within a first correction zone that comprises the at least one non-electrical correction stimulus and does not comprise the least one electrical correction stimulus. In some embodiments, the receiver unit is configured to deliver a second correction scheme to the animal when the receiver unit is positioned within a second correction zone that comprises the at least one non-electrical correction stimulus and the least one electrical correction stimulus, the second correction zone being positioned closer to the boundary wire than the first correction zone.

In some embodiments, the RSSI thresholds are user custom configured RSSI thresholds.

In some embodiments, the receiver unit selectively delivers the at least one electrical correction stimulus and/or the at least one non-electrical correction stimulus to the animal based on the extrapolated position of the receiver unit and at least one other factor. In some embodiments, the at least one other factor comprises a previously extrapolated position of the receiver unit, an operational parameter of the receiver unit, the status of timer regarding a previous delivery of the at least one electrical correction stimulus and authentication of the containment signals.

In another aspect, the present discloses provides an electronic animal containment system comprising: a boundary wire bounding a containment area, said boundary wire defining a safe zone within the containment area, at least one warning zone within the containment arca and at least one correction zone at least partially within the containment area, the at least one correction zone being positioned closer to the boundary wire that the at least one warning zone; a transmitter electrically coupled with said boundary wire, said transmitter generating a containment signal current in said boundary wire that produces a containment signal in the magnetic field emitted from the boundary wire; and a receiver unit configured to be carried by an animal, detect the containment signal, selectively deliver at least one electrical correction stimulus to the animal, and selectively deliver at least one correction stimulus to the animal based position of the receiver unit within the at least one warning zone or the at least one correction zone. The at least one safe zone, at least one warning zone and the at least one correction zone are positioned at respectively further distances from the boundary wire. The receiver unit is configured to extrapolate the position of the receiver unit within the safe zone, the at least one warning zone or the at least one correction zone by determining a digital received signal strength indication (RSSI) of the received signal strength of the containment signal and its relation to a plurality of user custom configured RSSI thresholds corresponding to boundaries of the at least one warning zone and the at least one correction zone.

In some embodiments, the receiver unit selectively delivers the at least one electrical correction stimulus and/or the at least one non-electrical correction stimulus to the animal based in part on the receiver unit being positioned within the at least one warning zone or the at least one correction zone.

In some embodiments, the receiver is configured to deliver differing correction schemes of differing electrical correction stimulus and/or non-electrical correction stimulus when the receiver unit is positioned within the at least one warning zone and the at least one correction zone. In some embodiments, the receiver unit is configured to deliver a first correction scheme to the animal when the receiver unit is positioned within the at least one warning zone that comprises the at least one non-electrical correction stimulus and does not comprise the least one electrical correction stimulus. In some embodiments, at least one non-electrical correction stimulus comprises at least one a tone stimulus, at least one light stimulus, at least one vibration stimulus and at least one olfactory stimulus, or a combination thereof. In some embodiments, the receiver unit is configured to deliver at least one second correction scheme to the animal when the receiver unit is positioned within the at least one correction zone that comprises the at least one non-electrical correction stimulus and the least one electrical correction stimulus. In some embodiments, the at least one correction zone comprises a first correction zone and a second correction zone that is positioned closer to the boundary wire than the first correction zone, and the receiver unit is configured to deliver a second correction scheme to the animal when the receiver unit is positioned within the first correction zone that comprises the at least one non-electrical correction stimulus and the least one electrical correction stimulus, and to deliver a third correction scheme to the animal when the receiver unit is positioned within the second correction zone that comprises the at least one non-electrical correction stimulus and the least one electrical correction stimulus that is greater than the least one electrical correction stimulus of the second correction scheme. In some embodiments, the receiver unit selectively delivers the at least one electrical correction stimulus and/or the at least one non-electrical correction stimulus to the animal based on the extrapolated position of the receiver unit and at least one other factor.

In some embodiments, the at least one other factor comprises a previously extrapolated position of the receiver unit, an operational parameter of the receiver unit, the status of timer regarding a previous delivery of the at least one electrical correction stimulus and authentication of the containment signals.

In some embodiments, the receiver unit is configured to measure and record RSSIs of the received signal strength of the containment signal at particular times during a zone boundary threshold setting mode of a receiver unit as the user custom configured RSSI thresholds. In some embodiments, the containment signal current is modulated.

In another aspect, the present disclosure provides, an electronic animal containment system comprising: a receiver unit configured to be carried by an animal, detect containment signal of defined frequencies in the magnetic field emitted from a boundary wire of an animal containment transmitter system, and selectively deliver at least one correction stimulus to the animal; and a user interface system comprising a graphical user interface, a processor and a speaker, and being configured to emit control signals in the defined frequencies in the magnetic field via the speaker. The receiver unit is configured to selectively deliver the at least one correction stimulus to the animal according to a containment scheme and based at least in part on an extrapolated distance of the receiver unit from the boundary wire. The receiver unit is configured to detect the control signals and custom configure at least one operational parameter of the at least one correction stimulus or the containment scheme according to the detected control signals.

In some embodiments, the containment scheme comprises at least one electrical correction stimulus and/or the at least one non-electrical correction stimulus. In some embodiments, the receiver unit is configured to extrapolate the position of the receiver unit in the defined correction zones by determining a digital received signal strength indication (RSSI) of the received signal strength of the containment signals and its relation to a plurality of RSSI thresholds. In some embodiments, the RSSI thresholds are user custom configured RSSI thresholds.

In another aspect, the present disclosure provides, a method of custom configuring containment zones of an electronic animal containment system, comprising: enabling a zone boundary threshold setting mode of a receiver unit that is configured to be carried by an animal, detect containment signals of defined frequencies in the magnetic field emitted from a boundary wire of an animal containment transmitter system, and selectively deliver at least one correction stimulus to the animal based at least in part on an extrapolated distance of the receiver unit from the boundary wire in relation to containment zones extending from the boundary wire; physically positioning the receiver unit at a user-selected first location positioned a first distance from the boundary wire; via the receiver unit, determining a first digital received signal strength indication (RSSI) of the received signal strength of the containment signals at the first location, and utilizing the determined first digital RSSI at the first location to configure a first RSSI threshold of a first containment zone where the receiver unit delivers a first correction stimulus scheme to the animal; physically positioning the receiver unit at a user-selected second location positioned a second distance from the boundary wire that is less than the first distance; and via the receiver unit, determining a second digital RSSI of the received signal strength of the containment signals at the second location, and utilizing the determined second digital RSSI at the second location to configure a second RSSI threshold of a second containment zone where the receiver unit delivers a second correction stimulus scheme to the animal that differs from the first correction stimulus scheme.

In some embodiments, receiver unit determines the first digital RSSI and records the determined first digital RSSI automatically at the expiration of a first countdown timer of the zone boundary threshold setting mode, and determines the second digital RSSI and records the determined second digital RSSI automatically at the expiration of a second countdown timer of the zone boundary threshold setting mode.

In some embodiments, the receiver unit emits at least one of a tone stimulus, a light stimulus and a vibration stimulus at the expiration of the first countdown timer and the at the expiration of the second countdown timer.

In some embodiments, enabling the zone boundary threshold setting mode of the receiver unit comprises sending corresponding control signals in the defined frequencies in the magnetic field to the receiver unit via a user interface control unit and a speaker.

In some embodiments, the user interface control unit comprises a graphical user interface (GUI), and wherein the GUI displays messages to the user to physically position the receiver unit at the user-selected first and second locations, and displays representations of the first and second countdown timers.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

These and other objects, features and advantages of this disclosure will become apparent from the following detailed description of the various aspects of the disclosure taken in conjunction with the accompanying drawings.

### BRIEF DESCRIPTION OF THE DRAWINGS

These and other features, aspects, and advantages of the present disclosure will become better understood when the following detailed description is read with reference to the accompanying drawings, which are not necessarily drawn to scale and in which like reference numerals represent like aspects throughout the drawings, wherein:

FIG. 1 illustrates, in one example, an electronic pet confinement system including a transmitter, a boundary wire and a receiver unit carried by a pet, in accordance with one or more aspects of the present disclosure.

FIG. 2 illustrates, in one example, a diagram of the operation of the boundary wire, and a magnetic field containment signal radiating therefrom with relevant distance noted, of the electronic animal containment system of FIG. 1, in accordance with one or more aspects of the present disclosure.

FIG. 3 illustrates, in one example, a diagram that charts signal strength of the magnetic field containment signal against distance from the boundary wire of the electronic animal containment system of FIG. 1, in accordance with one or more aspects of the present disclosure.

FIG. 4 illustrates, in one example, a block diagram of some of the components of the electronic animal containment system of FIG. 1, in accordance with one or more aspects of the present disclosure.

FIG. 5 illustrates, in one example, the electronic animal containment system of FIG. 1 configured with a safe zone, a warning zone and a correction zone comprising a first correction subzone and a second correction subzone, in accordance with one or more aspects of the present disclosure.

FIG. 6 illustrates, in one example, a warning zone, the first correction subzone and the second correction subzone of FIG. 5 with corresponding RSSI thresholds indicated in accordance with one or more aspects of the present disclosure.

FIG. 7 illustrates, in one example, a flow chart showing the configuration and operation of an RSSI-based correction feature of the electronic animal containment system of FIG. 1, in accordance with one or more aspects of the present disclosure.

FIG. 8 illustrates, in one example, a flow chart showing the configuration and operation of a user setting configuration feature of the receiver and a user control interface of the electronic animal containment system of FIG. 1, in accordance with one or more aspects of the present disclosure.

FIG. 9 illustrates, in one example, a flow chart illustrating a user setting configuration algorithm of the user control interface of FIG. 8, in accordance with one or more aspects of the present disclosure.

FIG. 10 illustrates, in one example, a graphical user interface of the user control interface during operation of the user setting configuration algorithm of FIG. 9, in accordance with one or more aspects of the present disclosure.

### DETAILED DESCRIPTION

Aspects of the present disclosure and certain examples, features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the relevant details. It should be understood, however, that the detailed description and the specific examples, while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. In some instances, the approximating language may correspond to the precision of an instrument for measuring the value.

Terminology used herein is for the purpose of describing particular examples only and is not intended to be limiting. As used herein, the singular forms “a”, “an” and “the” are intended to include the plural forms as well, unless the context clearly indicates otherwise. Furthermore, references to “one example” are not intended to be interpreted as excluding the existence of additional examples that also incorporate the recited features. Moreover, unless explicitly stated to the contrary, the terms “comprising” (and any form of “comprise,” such as “comprises” and “comprising”), “have” (and any form of “have,” such as “has” and “having”), “include” (and any form of “include,” such as “includes” and “including”), and “contain” (and any form of “contain,” such as “contains” and “containing”) are used as open-ended linking verbs. As a result, any examples that “comprises,” “has,” “includes” or “contains” one or more step or element possesses such one or more step or element, but is not limited to possessing only such one or more step or element. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

The terms “animal” and “pet” (and forms thereof) are used herein to broadly to refer to any living creature or being, and are not meant as limiting the type or classification of the living creature that may carry or utilize the receiver or the system otherwise. The electronic animal containment system and methods disclosed herein may be particular advantageous for use with animals that are kept by humans (e.g., as pets, service animals, livestock, or the like), but the systems and methods may equally be useful with other living creatures. In some embodiments, a mammalian animal (such as a canine, feline or other mammal) may carry the receiver unit of the system. In some such embodiments, the mammalian animal may be a human who carries/wears the receiver and/or otherwise uses the system as the “animal” or “pet.” In some other such embodiments, the mammalian animal may be a non-human animal who carries/wears the receiver and/or otherwise uses the system as the “animal” or “pet.” In some other such embodiments, a non-mammalian animal may carry/wear the receiver unit of the system and/or otherwise use the system as the “animal” or “pet.”

The term “user” and “administrator” (and forms thereof) are used herein to broadly to refer to any person that uses the systems and methods disclosed herein in any manner. In some embodiments, a “user” or “administrator” may be an end user who owns/controls the animal(s) that is/are contained by a system/method. In some embodiments, a “user” or “administrator” may be a dealer, installer, trainer, repair technician, manufacturer, licensee/licensor or another person who is not the end user, and who may be installing, repairing, reconfiguring, updating or otherwise using the system/method for the benefit of the end user, and potentially to configure the system/method for the end user and their particular animal(s). For example, a non-end user may initially setup the system/method for the end user, and/or change the settings/parameter of the system/method during a training process, update process, add an additional receiver, or to otherwise adjust the previous settings/parameter of the system/method

An electronic animal containment system is described herein and illustrated in the accompanying figures, and referenced generally by reference numeral 100. As described further below, the electronic animal containment system 100 include a transmitter 102 that is connected to a wire loop 104 which defines a boundary of a containment area 106 and emits a containment signal 107, and a receiver unit 118 responsive to the containment signal that is worn or otherwise carried by an animal 120 (such as a pet, for example a dog, cat, goat, pig, cow/cattle or other livestock). In some embodiments, the electronic animal containment system 100 actively determines, and digitally identifies, a current received signal strength indication (RSSI) by the receiver unit 118 (worn by the animal 120) an electromagnetic field emitted by the containment wire 104. The electronic animal containment system 100 is configured to use the identified RSSIs and user-defined RSSI correction thresholds to, in part, determine if the receiver unit 118 should issue a correction to the animal 120 according to a correction profile (programmed or saved within the receiver unit 118). The electronic animal containment system 100 is configured to allow a user to establish the user-defined RSSI correction thresholds based on one or more actual physical location of the receiver unit 118 with respect to the containment/boundary wire 104. In some such embodiments, the electronic animal containment system 100 is configured to enter a user threshold program mode via received electromagnetic signals emitted via a user interface that initiates and effectuates the programming of the user-defined RSSI correction thresholds saved in the receiver unit 118.

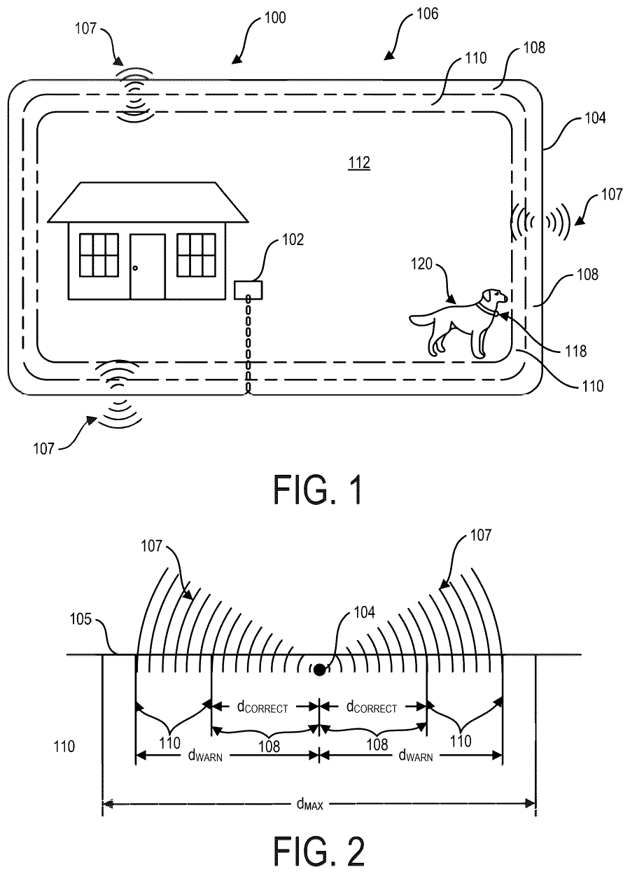

FIGS. 1-10 illustrate an exemplary electronic animal containment system 100 and/or features thereof, and methods relating to function and use thereof, according to the present disclosure. As shown in FIGS. 1 and 4-6, the containment system 100 includes a transmitter or signal generator 102 that is connected to a boundary or containment wire 104. The boundary wire 104 serves as a transmitting antenna of the transmitter 102 for emission of a magnetic field and/or electromagnetic containment signal 107. The transmitter 102 may include a signal generator processor 103 that generates a particular magnetic field signal. In some embodiments, the transmitter 102 may also include a modulator 109 to modulate the generated signal to output the containment signal 107 to/from the boundary wire 104.

The containment signal 107 may be a periodic/modulated carrier signal of one or more particular frequency which the receiver or rover unit 118 is configured to detect. The modulation (coded/periodic-a particular time on/emitted, and particular time off/non-emitted) may facilitate or enable the receiver unit 118 to identify/ensure that the signal is coming from the transmitter 102, such as by comprising particular ID code via the modulation. In some other embodiments, the containment signal 107 may not be modulated, and may be a continuous signal. In such embodiments, continuous containment signal 107 may comprise a frequency pattern (e.g., frequency deviation).

The magnetic field signal 107 is used by the system 100 for proximity determination (via RSSI) and identification. In some embodiments, the containment signal 107 may also include and be configured/used for configuration signals for the receiver unit 118. In some embodiments, the containment signal 107 may be emitted at very low frequencies, such as less than 15 KHz, such as within the range of about 5 KHz to about 13.5 KHz, or at about 7.5 KHZ (e.g., at ±0.075 kHz) or 10.9 KHz (e.g., at ±0.109 kHz). However, it is noted that other frequencies, such as magnetic field signals with other frequencies, may be utilized.

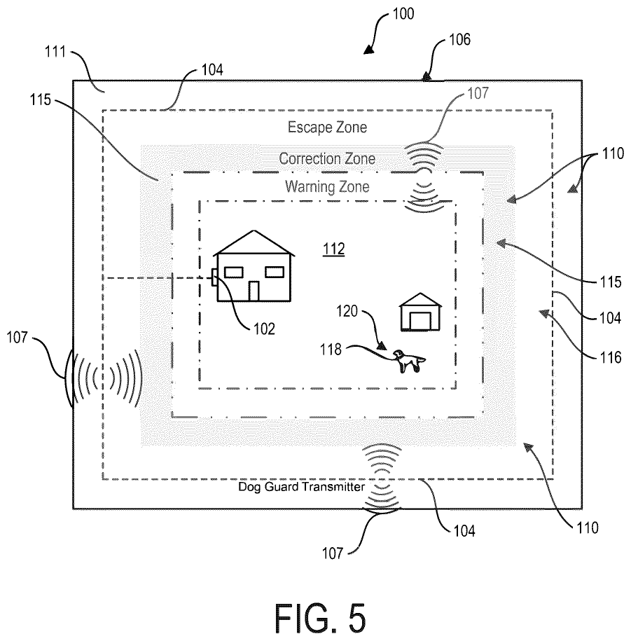

As shown in FIGS. 1 and 5, the boundary wire 104 may form a loop, and is represented in the drawings by an object line. The boundary wire 104 defines the boundary of an inner containment area 106 within the boundary/wire, and an area beyond the boundary, for the receiver unit 118. In the illustrated embodiment, the boundary wire 104 defines a perimeter within or on a residential yard (such that the perimeter of the yard) as the boundary, an inner part of the yard is the containment area 106 within the boundary, and the area outside the inner part of the yard is the area beyond the boundary from which the system 100 encourages/trains an animal 120 that carries the receiver or rover unit 118 against entering into. Those skilled in the art will recognize that the boundary wire 104 can define a boundary other than a perimeter in/of a residential yard without departing from the scope and spirit of the present disclosure. In one embodiment, the boundary wire 104 is buried in the ground such that the boundary wire 104 is not visible from the surface 105 of the ground and/or to protect the boundary wire 104 from damage.

As shown in FIGS. 1, 5 and 6, the receiver unit 118 is worn or otherwise carried by an animal 120. In the illustrated embodiment, the receiver unit 118 is worn on a collar on the animal 120. One skilled in the art will appreciate that the receiver unit 118 may be carried in other ways such as a strap, a harness, or animal clothing without departing from the scope and spirit of the present disclosure. It is noted that a system 100 may include one receiver unit 118, or a plurality of receiver units 118 carried by a plurality of separate and distinct animals 120.

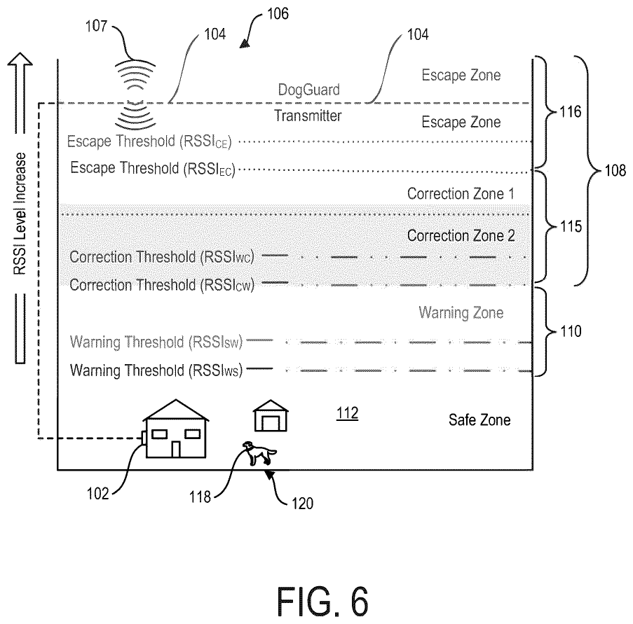

The dash-dot-dot line in FIGS. 1, 5 and 6 represents the edge of a correction zone 108 within the containment area 106, and the dashed-and-dotted line represents the edge of a warning zone 110 within the containment area 106. The correction zone 108 may or may not have correction subzones therein, such as base correction zone 115 and an escape zone 116, as shown in FIGS. 5 and 6.

As explained further below, the edge of the warning zone 110 at the safe zone 112 represents the position or distance d_{WARN} of the receiver unit 118 from the wire 104, that is set by the user, where the receiver unit 118 may issue at least one warning stimulus scheme to the animal 120 if the receiver unit 118/animal 120 moves further toward the boundary/containment wire 104 (depending on whether other factors or metrics are also satisfied, for example). As also explained below, the user-defined position or distance d_{WARN}, and the current relative position of the receiver unit 118 (and thus the animal 120) from the boundary wire 104, is extrapolating or determined by the system 100 (specifically the receiver unit 118) from a measured received signal/field strength indication (RSSI) of the containment signal/field 107.

Likewise, the closest edge (to the safe zone 112) of the correction zone 108/115 at the furthest edge of the warning zone 112 represents the position or distance d_{CORRECT} of the receiver unit 118 from the wire 104, that is set by the user, where the receiver unit 118 may issue at least one correction stimulus scheme to the animal 120 if the receiver unit 118/animal 120 moves further toward the boundary/containment wire 104. Again, the user-defined position or distance d_{CORRECT}, and the current relative position of the receiver unit 118 (and thus the animal 120) from the boundary wire 104, is extrapolating or determined by the system 100 (specifically the receiver unit 118) from a measured current RSSI of the containment signal/field 107.

As shown in FIGS. 5 and 6, the area bound by the warning zone 110 is a safe zone 112 in which the receiver unit 118 would not initiate any type of warning or correction scheme to the animal 120. The edge between the safe zone 112 and the warning zone 110 (the d_{WARN} distance/RSSI), and the current relative position of the receiver unit 118 (and thus the animal 120) from the boundary wire 104 within the safe zone 112 for example, is extrapolating or determined by the system 100 (specifically the receiver unit 118) from a measured current received signal/field strength indication of the containment signal/field 107. The portion of the wire loop from the transmitter 102 to the desired boundary location may be located within the safe zone 112, and typically has the ends of the wire loop twisted together or lying next to each other to effect the cancellation/mitigation of the containment signal 107 for that portion of the wire loop 104.

FIG. 2 illustrates the electromagnetic field radiating from a boundary wire 104 buried under the ground 105, where d_{MAX} is the maximum width of the boundary/containment field, d_{WARN} is the user selected distance from the boundary wire 104 at which the signal strength/RSSI reaches the level for the receiver unit 118 to apply a potential warning scheme (if other factors/metrics are met, for example), d_{CORRECT1} is the user selected distance from the boundary wire 104 at which the RSSI reaches the level for the receiver unit 118 to apply a potential first correction scheme (if other factors/metrics are met, for example), and dCORRECT2 is the user selected distance from the boundary wire 104 at which the RSSI reaches the level for the receiver unit 118 to apply a potential second correction scheme (if other factors/metrics are met, for example). For example, the value of d_{MAX} may be at approximately 50 feet when the transmitter 102 is operated at certain power level. This provides approximately 25 feet for both the warning zone 110 and the correction zone 108/115 within the containment boundary 106 in which a user can define the particular limits/positions/distances/RSSIs (e.g., d_{WARN}, d_{CORRECT1}, d_{CORRECT2}, etc.) for the potential application of warning and corrections schemes via the receiver unit 118.

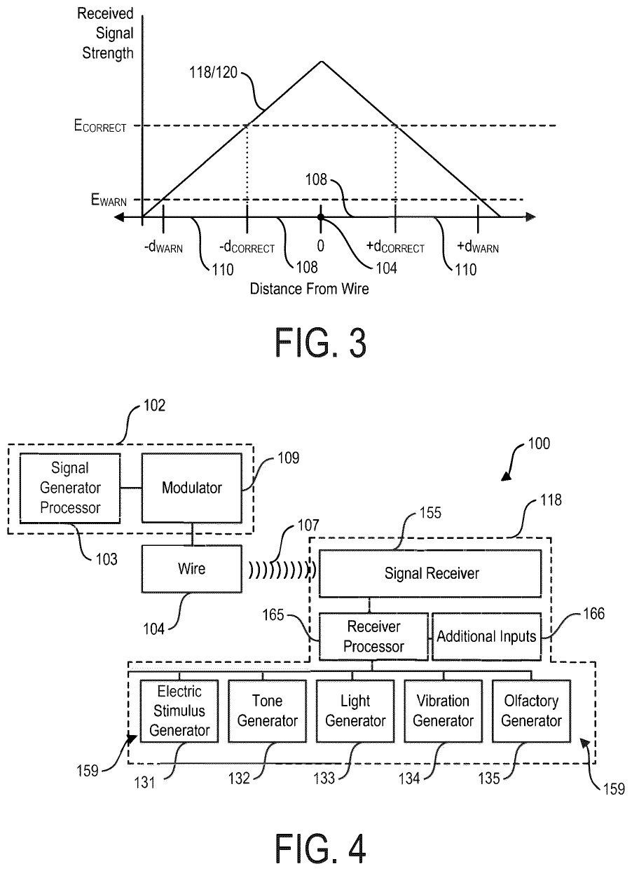

FIG. 3 charts the received signal strength (RSS) of the containment signal 107 against the physical distance from the boundary wire 104. By measuring the strength of the containment signal 107 received by the receiver unit 118, a RSSI can be determined and utilized to extrapolate relative proximity to the boundary wire 104 (e.g., with respect to user-programmed RSSIs determined at user-selected physical distances), as discussed further below. The closer the receiver unit 118 is carried to the boundary wire 104 by the animal 120, the stronger the received signal (and the receiver unit 118 determines/outputs a particular RSSI). As also discussed below, the receiver unit 118 compares current RSSIs to a user selected threshold RSSIs to determine whether a warning or correction scheme is appropriate based on RSS/distance of the receiver unit 118 (and thus the animal 120) (although such an appropriate scheme may or may not ultimately be applied if other factors considered by a correction control signal algorithm of the receive unit 118 are met/satisfied).

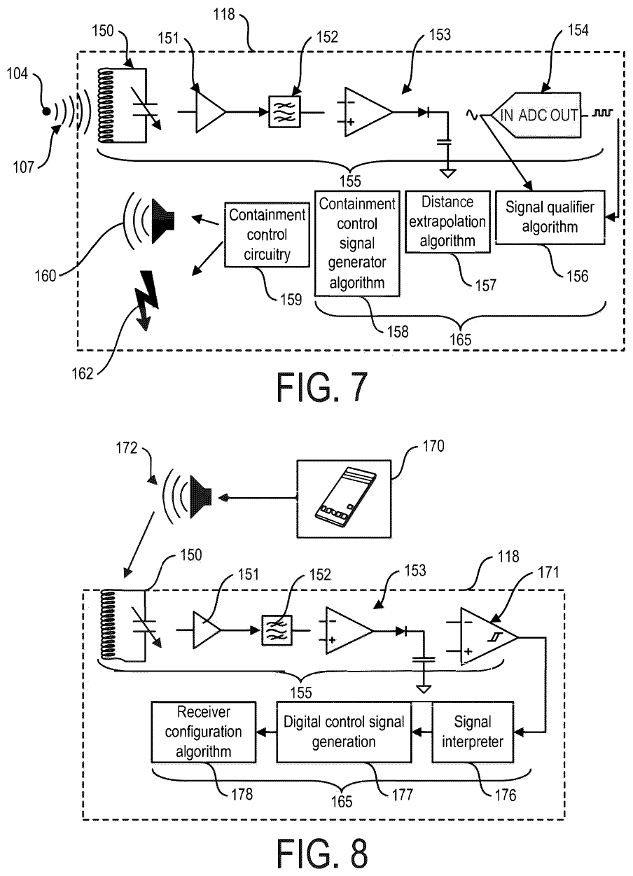

As shown in FIGS. 4 and 7, the receiver unit 118 may include a signal receiver 155 that is configured to measure the RSS of the magnetic field containment signal 107 and determine a current RSSI, and a receiver processor 165 that is configured to, inter alia, utilize the RSSI in connection with the user defined thresholds to determine whether to effectuate a particular containment scheme, such as a particular warning scheme 160 or a correction scheme 162, and ultimately potentially effectuate the particular containment scheme.

The transmitter 102 periodically transmits the magnetic field/signal 107, and the frequency of the transmitted field 107 can vary based upon range settings on the transmitter 102. However, the frequency of the transmitted field 107 is set at a particular frequency that is detectable by the receiver 104 when in range of the boundary wire 104. As shown in FIG. 7, the signal receiver 155 may include a frequency selective magnetic field sensor or tuned circuit/antenna 150 that is configured to receive/detect the magnetic field containment signal 107, and convert it to a processable electrical signal. In some embodiments, the magnetic field sensor 150 may include one or more pickup coils that are tuned to the particular frequency/frequencies of the transmitter 102. The one or more pickup coils of the magnetic field sensor 150 vibrate upon the incident transmitted field 107, and induce a voltage or electric/electronic signal.

In further reference to FIG. 7, the signal receiver 155 may further include an analog signal processing unit or components to determine the RSS of the containment magnetic field/signal 107. For example, the voltage induced on the receiver coil(s) due to the transmitted signal 107 can be as low as several micro-volts while still being detectable. Due to the extremely low signal levels, the signal receiver 155 may include a capacitor, and an amplifier 151 that amplifies the incoming signal from the capacitor through one or more amplification stages (that can gain the signal by 1,000 to over 100,000 to allow proper processing). The signal receiver 155 may also include at least one filter 152, such as band pass filter, and at least one signal demodulator 153, to detect the envelope (i.e., detect the amplitude) of the detected magnetic field containment signal 107, and thereby measure the RSS of the currently detected magnetic field containment signal 107. As also shown in FIG. 7, the signal receiver 155 may include an analog to digital converter 154 that converts the analog RSS determination/signal into a digital RSSI signal.

With the digital RSSI signal output by the signal receiver 155, as shown in FIG. 7, a distance extrapolation algorithm 157 of the receiver processor 165 of the receiver unit 118 can extrapolate how a current RSSI relates to user-defined/established threshold RSSIs (that correspond to user-selected physical distances of the receiver unit 118 from the boundary wire 104, as described further below), and thereby the distance of the receiver unit 118 (and thus the animal 120) from the boundary wire 104. For example, with reference to FIG. 6, the distance extrapolation algorithm 157 of the receiver processor 165 may determine whether a current detected RSSI (output by the signal receiver 155) is equal to, above or below at least one user-defined warning zone ingress threshold RSSI_{SW}, at least one user-defined warning zone egress threshold RSSI_{WS}, at least one user-defined correction zone ingress threshold RSSI_{WC}, at least one user-defined correction zone egress threshold RSSI_{CW}, at least one user-defined escape zone ingress threshold RSSI_{CE}, and/or at least one user-defined escape zone egress threshold RSSI_{EC} (or any combination thereof). The system may be configured such that a current determined RSSI must be above the respective ingress threshold RSSI and the respective egress threshold RSSI to apply the respective applicable correction scheme associated therewith. The ingress and egress thresholds may be advantageous to prevent hysteresis issues when the animal 120 is close to a border or edge between zones by preventing repeated/alternating correction schemes from being applied when an animal 120 is close to a border or edge between zones. It is noted that each warning and/or correction zone may comprise only a single zone, or may comprise a plurality of subzones with corresponding RSSI values. Similarly, each warning and/or correction zone/subzone may only have a single threshold rather, than an ingress threshold that is greater than a corresponding egress threshold.

It is noted that separate from (and potentially prior to) the distance extrapolation algorithm 157 extrapolating a current distance based on a current RSSI and user defined RSSI thresholds, the receiver processor 165 may be configured to ensure that the received signal is in fact a magnetic field containment signal 107 from the transmitter 102. As described above, the containment signal 107 may be modulated/coded, such that its specific periodic time on and time off pattern corresponds to an interpretable digital signal (i.e., 1s and 0s). In some such embodiments, the modulated containment signal 107 contains or includes a plurality of bits, such as a header bit and a plurality of data bits, which may include/correspond to a particular ID signal/code. In some other embodiments, the containment signal 107 may not bemodulated/coded to contain a particular ID signal/code, but only include a particular signal pattern (continuous signal with particular pattern).

Accordingly, a signal qualifier algorithm 156 of the receiver processor 165 may be configured to evaluate/qualify the data bits of the modulated/coded containment signal 107 to ensure that a proper transmitter/receiver ID code is received for an ID encoded signal, or evaluate/qualify the pattern of the continuous containment signal 107 for a non-modulated/non-coded signal, to ensure/validate that a received/detected containment signal 107 is in fact emitted by the transmitter 102 of the system 100 (and not noise, interference or any other “stray” signal, for example). It is noted that the signal qualifier algorithm 156 may analyze or qualify the containment signal 107 that is processed by a portion of the signal receiver 155, such as the signal before it passes to RSSI analog to digital converter 154 (e.g., the signal passing from the at least one signal demodulator 153 may be split), for example.

As shown in FIG. 7, if the receiver processor 165 determines that the containment signal 107 is being detected, a containment control signal generator algorithm 168 of the receiver processor 165 may be configured to derive an appropriate digital control signal dependent, in part, on how the current RSSI compares to the user defined containment RSSI thresholds, to modify the current containment scheme being applied by the receiver unit 118 to the animal 120. It is noted that the containment control signal generator algorithm 168 may take into account/consider/evaluate a variety of factors/metrics/conditions to derive an appropriate digital control signal above/in addition to how the current RSSI compares to the user defined containment RSSI thresholds. For example, the immediately previously determined RSSI and/or the current containment scheme being applied may be considered by the containment control signal generator algorithm 168, such as to evaluate whether the animal 120 is moving toward or away from the safe area 112 or a particular containment zone or RSSI threshold location (i.e., if a previously applied or the current correction scheme is working to properly deter the animal 120 from leaving the containment area 106, or if a progressive correction scheme is being applied that the stimulus is progressively enhanced as the animal 120 moves toward the boundary wire 104). As another example of a potentially considered factor, the parameters of the current containment scheme being applied may be considered by the containment control signal generator algorithm 168, as the parameters may dictate that the scheme should not be altered or a period of time. For example, in one embodiment, when it is determined that the receiver unit 118/animal 120 is in an escape zone at or proximate to the boundary wire 104, an aggressive escape correction scheme (examples described below) may be applied for a defined amount of time no matter how/where the receiver unit 118/animal 120 moves in relation to the boundary wire 104. As yet another example of a potentially considered factors, the containment control signal generator algorithm 168 may analyze data from additional inputs 166, such as time data from a timer, battery level data from a battery monitor, or directional movement data from an accelerometer, for example. It is noted that the containment control signal generator algorithm 168 of the receiver processor 165 may thereby be configured to derive an appropriate digital control signal dependent, only in part, on how the current RSSI compares to the user defined containment RSSI thresholds, that modifies the current containment scheme being applied by the receiver unit 118 to the animal 120.

If the containment control signal generator algorithm 168 of the receiver processor 165 derives and outputs an appropriate digital control signal that modifies the current containment scheme being applied by the receiver unit 118 to the animal 120, containment control circuity 159 of the receiver unit 118 (which may be analog and/or digital) may accept/receive the digital control signal. The containment control circuity 159 are effective in varying the operational parameters of at least one of a variety of different animal stimulus generators in relationship to the digital control signal (as defined by the particular applied containment scheme). In some embodiments, the receiver unit 118 may include at least one electric stimulus generator 131 (one or more transducer or transformer) configured to apply an electrical signal or shock to the animal 120 (e.g., via conducting probes extending from an inner side of the receiver unit 118), at least one tone stimulus generator 132 configured to emit an audible (to the animal 120) stimulus to the animal 120 (e.g., a speaker or sound transducer, such as piezoelectric sounder, for example), at least one light generator 133 configured to illuminate at least one light emitting device (e.g., at least one LED) as a visual stimulus (or notification to a user), at least one vibration stimulus generator 134 configured to apply vibrations to the animal 120, and/or at least one olfactory stimulus generator 135 configured to emit an olfactory stimulus (e.g., emit an amount of a foul smelling/odorous (to the animal 120) substance) that the animal 120 would smell, or a combination thereof.

In some embodiments, the receiver unit 118 may be configured such that it does not determine RSSI values while the at least one electric stimulus generator 131 generates an electrical correction signal. For example, the receiver unit 118 may be configured such the receiver processor 165 and/or the containment control signal generator algorithm 168 are deactivated or “off” when the at least one electric stimulus generator 131 generates an electrical correction signal. The RSSI determination may thereby be paused or turned off (e.g., the components and/or circuits used to determine the RSSI may be powered down) while the at least one electric stimulus generator 131 generates an electrical correction signal. It is noted that an electrical correction signal and/or a transformer that generates it may produce a magnetic field that interferes with the magnetic field sensor or tuned circuit/antenna 150, and thereby interferes with the containment signal 107/RSSI determination. Further, the electrical correction signal may require a relatively large amount of power from receiver 118. Accordingly, by turning off the RSSI detection when the when the at least one electric stimulus generator 131 generates an electrical correction signal, the receiver 118 is capable of delivering a higher level and/or intensity of correction signal and eliminates/mitigates RSSI determination errors resulting from the production of the electrical correction signal.

In some embodiments, the receiver unit 118 may be configured to generate the electrical correction signal via the at least one electric stimulus generator 131 as a series of pulses, which may each last for fractions of a second. For example, the electrical correction signal may be emitted for microsecond pulses (e.g., 1 microseconds, 20 microseconds, 100 microseconds, 500 microseconds, or 750 microseconds, etc.). The pulses may be separated/spaced by a consistent or variable amount of time, such as for example tens or thousands of a second. Further, in some embodiments, the length of the pulses and/or the intervals/pattern of the pulses, may be set or selectable by a user. In embodiments where the containment signal 107 is modulated, the receiver unit 118 may be configured to generate/emit the electrical correction signals via the at least one electric stimulus generator 131 during one or more gap or space in the modulation (i.e., when the signal is the off/non-emitted). In embodiments where the containment signal 107 is a continuous signal (i.e., not-modulated), the receiver unit 118 may be configured to stop determining RSSI periodically and emit the generate/emit the electrical correction signals respectively, such as for example at two or more times per second. It is noted that the total length of a complete containment signal 107 may be less than a second. For example, a containment signal 107 may repeat multiple times per second, such as, for example purposes only, 5 times per second.

In some exemplary embodiments that include an audible or tone stimulus, the at least one tone stimulus generator 132 may be configured to emit a variety of differing tones at a variety of differing octaves. In some such embodiments, the tones and octaves include tones at octaves that are not audible to the human car (ultrasonic), but are heard by an animal 120, such as a canine. For example, the at least one tone stimulus generator 132 may be configured to emit sound with frequencies above about 20,000 Hz, or above about 30,000 Hz, or above about 40,000 Hz, such as up to about 47,000 Hz or about 65,000 Hz. It is also noted that the parameters of the animal stimulus generators set by the containment control signal generator algorithm 168 and the containment control circuity 159 according to a particular containment scheme may be set or defined by a user and/or administrator, or by a predefined profile setting that is selected by a user and/or administrator.

In one exemplary containment scheme, which may be applied/effectuated when the current RSSI indicates that the receiver unit 118/animal 120 is in the safe zone 112, for example (potentially when other parameters are also met), the containment control signal generator algorithm 168 and the containment control circuity 159 may turn off all stimulus generators 131-135 such that the receiver unit 118 does not apply any stimulus to the animal 120. As another exemplary containment scheme, that may be applied/effectuated when the current RSSI indicates that the receiver unit 118/animal 120 is in a warning zone 110, for example (potentially when other parameters are also met), the containment control signal generator algorithm 168 and the containment control circuity 159 may be configured to apply/emit a warning containment scheme that includes non-electric shock stimulus to the animal 120. For example, an exemplary warning scheme may include at least one audible stimulus, at least one light stimulus, at least one vibration stimulus, at least one olfactory stimulus or a combination thereof. It is also noted that there may be multiple warning zones 110 with respective warning schemes, or there may be a warning zone 110 itself, with at least one non-shock parameter that progressively escalate in intensity, annoyance and/or irritation to the animal 120 (e.g., increasing pitch and/or amplitude of a warning tone) as the animal approaches to the boundary wire 104 (i.e., moves toward, and thereby a stronger RSSI is determined). It is further noted that a particular warning scheme may include an intra-zone progression with at least one non-shock parameter that progressively escalates in intensity, application time, annoyance and/or irritation to the animal 120 (e.g., increase in pitch and/or amplitude of a warning tone) as the RSSI indicates the animal 120 is moving further away from the containment area 106 and toward the boundary wire 104 (i.e., a stronger RSSI is determined) but is still within the particular warning zone.

In another exemplary containment scheme, that may be applied/effectuated when the current RSSI indicates that the receiver unit 118/animal 120 is in a correction zone 108/115 (e.g., a first correction zone, a second correction zone, an escape zone, etc.), for example (potentially when other parameters are also met), the containment control signal generator algorithm 168 and the containment control circuity 159 may be configured to apply/emit an electric shock stimulus to the animal 120, and potentially at least one non-electric shock stimulus. For example, a first exemplary correction scheme such as for an initial correction zone may include at least one audible/tone stimulus and a shock stimulus, and a second exemplary correction scheme for a secondary correction zone that is positioned further away from the containment area 106 than the initial correction zone (i.e., positioned closer to the boundary wire 104) may include at least one audible/tone stimulus, at least one vibration stimulus and a shock stimulus of a greater intensity, greater application time, greater voltage, greater number of pulses, shorter pulse interval and/or longer correction interval than that of the first exemplary correction scheme. The non-shock stimulus of the second exemplary correction scheme may also be more aggressive/stronger than that of the first exemplary correction scheme. Still further, an exemplary escape correction scheme an escape correction zone 116 that is positioned at or closest to the boundary wire 104, and thereby indicative of the animal 120 leaving the containment area 106, may include at least one non-shock stimulus and a shock stimulus that are applied for a preset amount of time (by the user or an administrator) regardless of the RSSI/location of the receiver unit 118. The shock stimulus of an escape correction scheme may or may not be of a greater intensity, greater application time, greater voltage, greater number of pulses, shorter pulse interval and/or longer correction interval than that of a correction scheme.

In some embodiments, a respective correction zone 108/115 and/or escape correction zone 116, one or more sub-zones thereof, may be configured with a progressive correction such that at least one stimulus parameter progressively escalates in intensity, annoyance and/or irritation to the animal 120 as the animal moves within the particular zone/sub-zone toward the boundary wire 104. The progressive correction may be configured to escalate from a minimum correction level (such as no correction or a low/“light” correction) when the animal enters the particular zone/sub-zone (i.e., the determined RSSI meets the ingress boundary RSSI threshold for the particular zone/sub-zone (and egress boundary RSSI threshold) to the maximum correction level set by the user for the particular zone/sub-zone as the animal 120 reaches or nears (e.g., is within a particular distance/RSSI from) the end of the particular zone/sub-zone (i.e., the determined RSSI meets an egress or ingress boundary RSSI threshold of an adjacent correction zone/subzone). It is further noted that a particular correction zone 108/115 and/or escape correction zone 116 may include an intra-zone progression of with at least one stimulus parameter that progressively escalates in intensity, annoyance and/or irritation to the animal 120 as the RSSI indicates the animal 120 is moving further away from the containment area 106 (but still within the particular zone).

As noted above, the containment control signal generator algorithm 168 may take into account/consider/evaluate a variety of factors/metrics/conditions to derive an appropriate digital control signal, or lack thereof, above/in addition to how the current RSSI compares to the user defined containment RSSI thresholds. For example, in some embodiments, the receiver 118 may comprise at least one accelerometer and/or at least one gyroscope, which is/are configured measure at least one of linear acceleration, motion, tilt, shake, angular rotational velocity, etc. The receiver 118 may thereby be configured to determine one or more movement characteristics of the receiver 118, and thereby one or more movement characteristics of the receiver 118 of the animal 120 wearing the receiver 118. In such embodiments, the containment control signal generator algorithm 168 may take into account/consider/evaluate the movement of the receiver 118/animal 120 when deriving an appropriate digital control signal or lack thereof.

In some embodiments, the receiver 118 may determine that a turnaround event has occurred based on the movement of the receiver 118/animal 120 determined/measured by at least one accelerometer and/or at least one gyroscope of the receiver unit. A turnaround event corresponds to the receiver 118/animal 120 changes its path of movement into a substantial different direction, such as substantially opposing direction. The receiver 118 may include an algorithm that parses the motion/acceleration/velocity data from the at least one accelerometer and/or at least one gyros and determines/detects a turnaround event based thereon.

In some embodiments, a turnaround event may comprise a determination that the animal physically turned around by analyzing accelerometer data from at least one accelerometer of the receiver 118. For example, the receiver 118 determine that a turnaround event has occurred by determining that accelerometer data from at least one accelerator of the receiver 118 comprises angular velocity or acceleration values from the at least one accelerometer above a (defined) threshold for at least a defined (threshold) time period. In some embodiments, the analyzed accelerometer data may comprise acceleration and/or velocity data (angular velocity or acceleration values) in an XY plane of the accelerometer and/or receiver 118.

In some embodiments, the receiver 118 (e.g., the containment control signal generator algorithm 168) may be configured to stop/cease a determined and currently applied warning and/or correction stimulus when a turnaround event occurs. For example, if the receiver 118 (e.g., the containment control signal generator algorithm 168) applies a warning and/or correction stimulus based on a determined RSSI reading, and a turnaround event is thereafter determined/measured while the warning and/or correction stimulus is still being applied to the animal 120, the receiver 118 (e.g., the containment control signal generator algorithm 168) may stop or cutoff the applied warning and/or correction stimulus. As another example, in some embodiments the receiver 118 (e.g., the containment control signal generator algorithm 168) may configured to pause or prevent a warning and/or correction stimulus based on a determined RSSI reading for a period of time after an applied warning and/or correction stimulus and a turnaround event. In such embodiments, when a warning and/or correction stimulus is applied based on a determined RSSI reading, such as an escape correction scheme when the animal 120 enters an escape zone 166 for example, and a turnaround is thereafter detected (e.g., within a particular amount of time), the receiver 118 (e.g., the containment control signal generator algorithm 168) may be configured to prevent or not apply a warning and/or correction stimulus based on subsequent RSSI readings. For example, the receiver 118 (e.g., the containment control signal generator algorithm 168) may be configured to prevent or not apply a warning and/or correction stimulus based on subsequent RSSI readings for a particular period of time after a warning and/or correction stimulus is applied and a subsequent turnaround event is detected/determined, or when the animal 120/receiver 118 is located within a particular zone (e.g., the safe zone 112) as determined by subsequent RSSI readings. In this way, the receiver 118 (e.g., the containment control signal generator algorithm 168) may configured to provide warning and/or correction stimulus immunity after a turnaround event occurs in close time proximity to an applied warning and/or correction stimulus to encourage/not interfere with the movement of the animal 120 along its direction of movement, which will be/likely be toward the safe zone 112.

In some embodiments, the receiver 118 (e.g., the containment control signal generator algorithm 168) may configured to apply a correction scheme (e.g., an escpae correction scheme) even though one or more determined digital RSSI values are not above an RSSI threshold of a correction zone (e.g., an escape correction zone) if the receiver 118 (e.g., the containment control signal generator algorithm 168) determines a plurality of increasing determined digital RSSIs followed by a plurality of decreasing determined digital RSSIs after at least one determined digital RSSI is above at least one initial digital RSSIs threshold of at least preceding correction zone (i.e., a correction zone spaced further from the wire with lower determine RSSI values and threshold(s)) and a determination that the animal 120 has not turned around (i.e., that a turnaround event has not been determined or detected). For example, the receiver 118 (e.g., the containment control signal generator algorithm 168) may configured to apply an escape or particular correction scheme even though one or more determined digital RSSI values are not above a corresponding RSSI correction threshold if the receiver 118 (e.g., the containment control signal generator algorithm 168) determines and/or detects at least one determined digital RSSI above at least one initial digital RSSIs threshold of a preceding correction zone and a plurality of increasing determined digital RSSIs followed by a plurality of decreasing determined digital RSSIs and a determination that the animal 120 has not turned around (i.e., that a turnaround event has not been determined or detected).

In some embodiments, the system 100 may be configured to be configured, controlled, programmed or updated (or reconfigured or reprogrammed) such that at least one control parameter of the receiver unit 118 is defined, set or selected, such as by a user and/or an administrator, via one or more corresponding control signal from a control interface unit 170, as shown in FIG. 8. As also shown in FIG. 8, the control interface unit 170 is configured to provide said at least on cone control signal to the signal receiver 155 of the receiver unit 118, and more particularly the magnetic field sensor or antenna 150 of the receiver unit 118.

The at least one control parameter of the receiver unit 118 that may be set through use of the control interface unit 170 may be any parameter that effects the containment operations of the receiver unit 118. For example, in some non-limiting examples, the control interface unit 170 may configured to allow a user/administrator to set the number of containment zones (number of warning zones (if any) and/or number of correction zones), a parameter of the configuration of the containment zones (e.g., the applicable RSSI thresholds/distances), the stimulus parameters of each containment zone (e.g., types of applied/not-applied correction stimulus, levels/parameters of correction stimulus, progressive stimulus, etc.), pre-defined modes or configuration setting (e.g., initiate and/or run a test mode, diagnosis mode, maintenance mode, setup mode, select pre-defined containment zones, select pre-defined containment schemes (e.g., large animal, medium animal or small animal containment schemes), etc.) or the like.

In some embodiments, the control interface unit 170 may comprise any computing device capable of running an algorithm or software application that is capable of generating digital control signals that, ultimately, are received by the signal receiver 155 of the receiver unit 118. For example, the control interface unit 170 may be a smartphone, tablet, laptop computer, any other mobile computing platform, desktop computer or any other processing device with (or that mates with) a user interface (such as a GUI or the like) and input device (such as a touch screen, mouse, keyboard or the like). In one exemplary embodiment, as shown in FIG. 8, the control interface unit 170 is a smartphone, and a software application that runs on the smartphone comprises the digital control signal algorithm.

In order to utilize the signal receiver 155 of the receiver unit 118, and more particularly the magnetic field sensor 150 of the receiver unit 118, the digital control signal algorithm of the control interface unit 170 may be capable of generating a coded audio tone based on each respective desired digital control signal. The control interface unit 170 may thereby also include, or may operatively couple with, a communication mechanism 172 that converts the coded audio tone to a coded magnetic field/signal that is configured to be detected by the magnetic field sensor 150 of the receiver unit 118. For example, the emitted/produced magnetic field/signal may be of a frequency and amplitude (and any other appropriate parameter) that the one or more coils of the magnetic field sensor 150 picks up (i.e., vibrates and produces a corresponding electrical signal). For example, in one non-limiting example, the emitted/produced coded magnetic field/signa may be at about 7.5 KHz (e.g., at ±0.075 kHz) or about 10.9 KHz (e.g., at ±0.109 kHz).

In some embodiments, the communication mechanism 172 is at least one speaker or sound transducer of the control interface unit 170 (e.g., a smartphone speaker). In some other embodiments, the communication mechanism 172 is at least one speaker that is electronically coupled (wired or wirelessly, such as via a cord or dongle or via Bluetooth®) to the control interface unit 170, and is remote (i.e., separate and distinct) from the control interface unit 170 itself. It is noted that in such embodiments, the speaker may be capable of emitting an audible signal/tone via physical vibration of at least one diaphragm or the like that vibrates air, such as via at least one magnetic component that produces a fixed magnetic field and a voice coil (or the like) (e.g., a relatively tightly wound wire coil) that produces/creates a magnetic field as electricity flows through it from an electrical signal (typically from an amplifier). The voice coil or like of the speaker, which produces a magnetic field when current is passed therethrough, can thereby be utilized by the control interface unit 170 to produce a (modulated) carrier signal in the magnetic field based on the digital control signal that is modulated with control/configuration signals. The coded digital control signal can thereby comprise a tone signal that produces the modulated magnetic field control/configuration signals via the communication mechanism 172.

As shown in FIG. 8, the signal receiver 155 of the receiver unit 118 may include electronic components that detects and distinguishes the modulated magnetic field control/configuration signals from the control interface unit 170 from other magnetic signals, demodulates the signal, and converts the signal into a corresponding digital signal/pulses (i.e., a corresponding received digital control signal), such as via at least one magnetic field sensor 150, at least one amplifier 151, at least one signal demodulator 153, and at least one comparator 171 to output a digital or logic level output signal (e.g., binary signal). It is noted that the incoming signal detected by the signal receiver 155 may be split prior to passing to the converter 154 for the digital RSSI signals, such that one path goes to the converter 154, and at least other path that is used for control signal transmission, as explained below) (and, potentially, for the signal authenticity verification via the signal qualifier algorithm 156, as described above). In some embodiments, the incoming signal detected by the signal receiver 155, whether it be a containment signal 107 or a control signal, is split between the converter 154 and at least one separate path to the signal qualifier algorithm 156 and the signal interpreter algorithm 176 described below (via the separate paths or the same path, such as from the at least one comparator 171).

As also shown in FIG. 8, the receiver processor 165 of the receiver unit 118 may include a plurality of algorithms that effectuate the custom configuration of the receiver unit 118 that correspond to the specific control signals send by the control interface unit 170. In some embodiments, the receiver processor 165 may include a signal interpreter algorithm 176 that is configured to parse the received digital control signal and determine if, and what, particular control codes or instructions were received. This is, the signal interpreter algorithm 176 may analyze all of the digital signals from the signal receiver 155 (e.g., from the at least one comparator 171) to determine if they contain digital control signals to update or set one of the various control parameters of the receiver unit 118.

If the signal interpreter algorithm 176 determines or interprets that a control signal from the control interface unit 170 was received from the signal receiver 155 of the receiver unit 118, a signal interpreter algorithm 177 of the receiver processor 165 may act on the determined/interpreted control signal, as shown in FIG. 8. In some embodiments, the signal interpreter algorithm 177 is configured to generate at least one receiver digital control signal based on the determined/interpreted control signal. The receiver digital control signals may correspondingly custom configure one or more of the parameters/setting of the receiver unit 118, as described above. Further, as also shown in FIG. 8, the receiver digital control signals may initiate another receiver configuration algorithm 178 of the receiver processor 165. The receiver configuration algorithm 178 may require or utilize other inputs, such as user inputs or user coordinated or facilitated inputs, which obtains or creates one or more configuration setting or parameter, and then ultimately generate at least one receiver digital control signal that correspondingly custom configures one or more of the parameters/setting of the receiver unit 118.

The control interface unit 170 thereby functions as a user interface that allows a user to set various parameters for the transmitter. The control interface unit 170 communicates with the signal receiver 155 of the receiver unit 118, which controls (via the receiver processor 165) the custom selection or setting of operational parameters/modes of the receiver unit 118. The control interface unit 170 may include a computer program or software application (e.g., designed to run on a mobile device) that facilitates the user entering or selecting the particular operational parameter and/or modes of the receiver unit 118.

In some embodiments, the system 100 is configured to perform a zone delineation or animal containment customization/configuration/calibration method or process via the control interface unit 170 and a particular receiver unit 118 that customizes/establishes the RSSI thresholds corresponding to the at least one warning zone (if utilized) and the at least one containment zone (if utilized) during operation of the system 100. The animal containment customization method establishes/calibrates the custom RSSI thresholds via actual physical distances of the particular receiver unit 118 from the boundary wire 104 that are set/determined by the user. The animal containment customization method may also allow the user/administrator to set/customize other control parameters of the system 100 in addition to the custom RSSI thresholds, as described above.

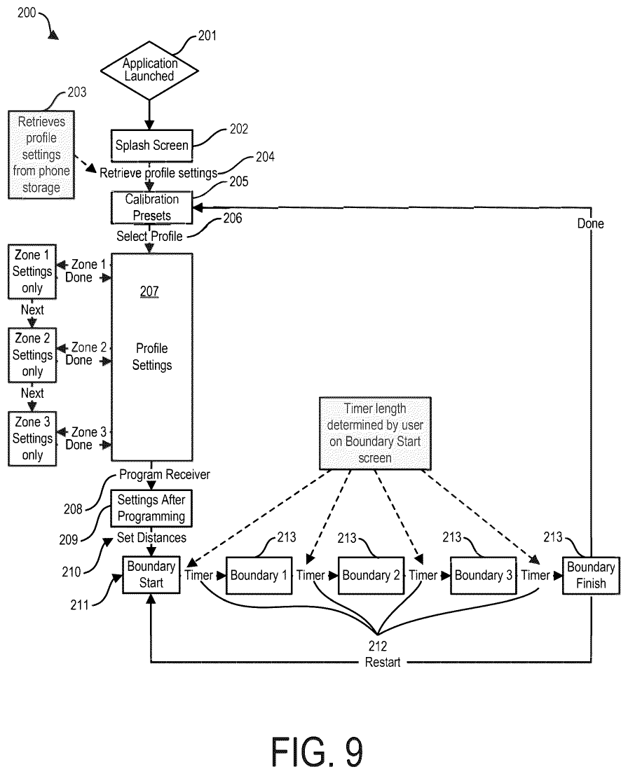

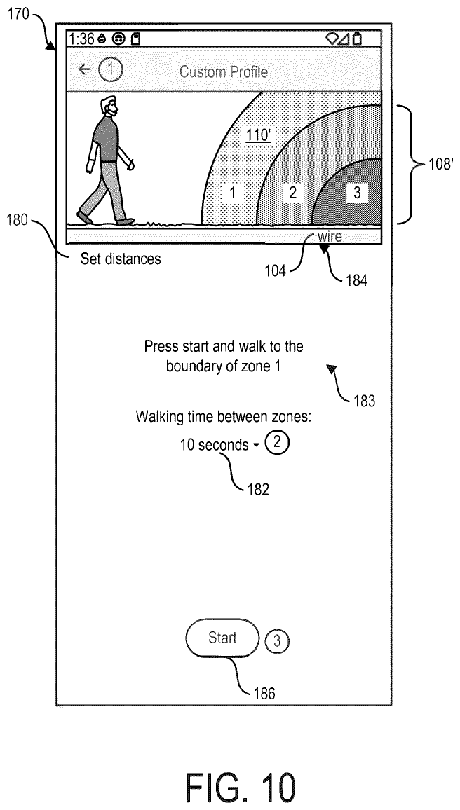

As shown in FIGS. 9 and 10, the customization method of the system 100 may include an animal containment customization program or application 200 that is run on the control interface unit 170. With reference to FIG. 9 that illustrates one exemplary flow of the customization application 200, the customization application 200 may initially be launched by the user at 201, and display a splash screen on the GUI of the control interface unit 170 at 202. In some embodiments, the splash screen may indicate to the user that the application 200 is for the customization/configuration of the electronic animal containment system 100, and/or display brand, software version, last software update information and/or other information of the electronic animal containment system 100.

As shown in FIG. 9, the animal containment customization application 200 may retrieve profile/scheme settings at 204, before displaying calibration presets menu on the GUI of the control interface unit 170 at 205. The calibration presets menu may display a plurality of preset containment profiles comprising differing configuration parameters/settings. For example, in some embodiments, the calibration presets menu may include at least one standard/base/default/preset correction profile and/or at least one custom correction profile. In some such embodiments, the calibration presets menu mat include a plurality of default containment profiles with containment stimulus settings/parameters that may be appropriate for differing types or categories of animals. For example, the default containment profiles may include a light correction default profile that includes containment setting/parameters for a small sized animal 120 or an animal 120 that does not require an aggressive correction stimulus scheme to be contained, a medium correction default profile that includes containment setting/parameters for a medium sized animal 120 or an animal 120 that does not require an aggressive correction stimulus scheme to be contained but requires a correction scheme more aggressive that the light correction default profile, a strong correction default profile that includes containment setting/parameters for a large sized animal 120 or an animal 120 that requires an aggressive correction stimulus scheme to be contained, or a combination thereof. The at least one custom correction profile can be a custom profile that the user previously created.

The calibration presets menu may allow the user to add new custom correction profiles, delete profiles, duplicate profiles, rename the profiles, reorder the display of the profiles. The calibration presets menu also allows the user to select which correction profile they would like to use, and potentially customize or adjust the settings thereof. The calibration presets menu may thereby also display the at least some of the correction scheme parameters/settings of the correction profiles to allow the user to see at least some of the current settings of the parameters/settings of the correction profiles before choosing/selecting one of the profiles to utilize.

As noted above, prior to loading and displaying the calibration presets menu at 205, the customization application 200 may retrieve profile/scheme settings at 204 so that the displayed profiles include the updated/previously selected correction parameters/settings that the user previously chose (or default profiles if no updates have been made). In some such embodiments, the profile settings data may be stored in memory of the control interface unit 170, and the retrieval of the profile/scheme settings at 204 may thereby comprise retrieving the profile/scheme settings from the memory of the control interface unit 170 at 203, as shown in FIG. 9. In some other embodiments, the profile settings data may be stored in memory remote to the control interface unit 170, such as in the cloud or on a particular server, and the retrieval of the profile/scheme settings at 204 may thereby comprise retrieving the profile/scheme settings from the respective memory device/location.

As shown in FIG. 9, after the user selects a particular correction profile at the calibration presets menu via the input device of the control interface unit 170 (e.g., tough screen, mouse, etc.) at 206, a profile setting screen or menu that displays at least some aspects of the correction scheme of the selected correction profile may be displayed on the GUI of the control interface unit 170 at 207. For example, in some embodiments, the profile setting screen may display the current/default correction zones of the selected correction profile, and potentially the current/default stimulus settings of the correction zones. In some such embodiments, the profile setting screen may display a first correction zone (e.g., a warning zone) and the correction/stimulus settings thereof (if any), a second correction zone (e.g., a correction zone) and the correction/stimulus settings thereof (if any), a third correction zone (e.g., an escape zone) and the correction/stimulus settings thereof (if any).

The profile setting screen may also allow the user to customize/edit/select/configure the correction/stimulus settings/parameters of the correction zone(s) of the selected correction profile. For example, for each correction zone of the selected correction profile, the profile setting screen may allow the user to select the zone, and access and display an individual zone setting screen/window/menu with the current and potential correction/stimulus settings/parameters, and allow the user to customize the settings. As discussed above, a receiver unit 118 may provide for electrical/shock stimulus, tone/sound stimulus, light stimulus, vibration stimulus, olfactory stimulus, or a combination thereof. Accordingly, the setting screen or a sub-screen/window/menu may allow a user to select an electrical/shock level (which may include a particular shock profile of parameters, such as intensity, length/pattern of application, frequency, etc.) from a plurality of levels, a tone level (which may include a particular tone profile of parameters, such as note, octave, length/pattern of application, etc.) from a plurality of levels, a light level (which may include a particular light profile of parameters, such as color, intensity, length/pattern of application, etc.) from a plurality of levels, a vibration level (which may include a particular vibration profile of parameters, such as intensity, length/pattern of application, etc.) from a plurality of levels, a olfactory level (which may include a particular olfactory profile of parameters, such as volume dispensed, length/pattern of application, etc.) from a plurality of levels, or a combination thereof.

The setting screen or a sub-screen/window/menu may also allow a user to select whether or not a particular correction/stimulus should be applied progressively (i.e., applied level of correction/stimulus ramps up to selected level) as the animal 120 moves within the particular zone further toward the boundary wire 104. Still further, in some embodiments, the setting screen or a sub-screen/window/menu may also allow a user to select a correction/stimulus timeout time setting that automatically stops the application of the particular correction/stimulus after the expiration of a particular amount of time, such as for the correction/stimulus in an escape/boundary zone. In some embodiments, the profile setting screen may prevent a user from customizing the correction/stimulus settings/parameters of the correction zone(s) of a selected default correction profile.

In some embodiments, the profile setting screen may display, and allow the user to enter or update, the serial or identification number/code (or the like) of the receiver unit 118 that the application 200 is to configure/customize. In such embodiments, the control interface unit 170 may transmit the entered receiver serial number with the control signals, and the receiver processor 165 of a receiver unit 118 that receives the control signals may include an algorithm (e.g., the interpreter algorithm 176, or another algorithm) that authenticates the receiver serial number (i.e., checks to ensure that it matches the serial number of the respective receiver unit 118) before processing the control signals and configuring/customizing the settings/parameters thereof. In some embodiments, the profile setting screen may display, and allow the user to enter or update, the frequency of the containment signal 107 (and potentially if the signal is coded or non-coded) emitted by the transmitter 102 and boundary wire 104 of the respective system 100 so that the receiver unit 118 effectively detects and processes the proper emitted containment signal 107.

As shown in FIG. 9, once the user is satisfied with the configuration/customization of the correction stimulus parameters/settings/scheme of each zone of the selected profile, the user may initiate and effectuate the process/method of configuring/customizing the respective receiver unit 118 with the user's correction stimulus parameters/settings/schemes via corresponding control signals (as discussed in detail above) in the profile setting screen (e.g., selecting a respective icon/button via the input device of the control interface unit 170) at 208. After the receiver unit 118 is configured/customized with the user's correction stimulus parameters/settings/schemes (including the particular zones of the selected profile), the application 200 may display a profile settings after configuration screen on the GUI of the control interface unit 170 at 209, as shown in FIG. 9. The profile settings after configuration screen may provide an overview of the saved settings for the selected profile (e.g., the profile name, containment signal 107 frequency, correction/stimulus types and levels/values/settings etc.). In some embodiments, the settings after configuration screen may allow the user to selectively test the operation of the selected correction/stimulus settings/parameters on the receiver unit 118 of each of the correction zone(s) of the selected correction profile.

In some embodiments, the profile settings after configuration screen may also allow the user to initiate the method of configuring/customizing the boundary distances/RSSI thresholds (as discussed in detail above) at 210, such as by selecting a respective icon/button via the input device of the control interface unit 170, as shown in FIG. 9. If a user initiates the boundary distances/RSSI thresholds configuration/customization method, the application 200 may display a zone distance setting method start screen 180 on the GUI of the control interface unit 170 at 211, as shown in FIGS. 9 and 10.

As shown in FIG. 10, the zone distance setting start screen 180 may display a representation 184 of the wire 104 and the correction zones 108′, 110′ of the profile and settings selected/configured/customized by the user, and an indication that the distances of the boundary/boundaries of the zone(s) thereof can be set by this portion of the application 200. As also shown in FIG. 10, the zone distance setting start screen 180 may also provide an instruction 183 for the user to physically position the receiver unit 118 at the starting boundary location or distance from the boundary wire 104 of the first/initial correction zone of the selected profile that the animal 120/receiver unit 118 would reach when moving from the safe zone 112 toward the boundary wire 104 (i.e., the end of the safe zone 112), and to substantively move the receiver unit 118 for each zone. Accordingly, the user must physically position the receiver unit 112 at respective locations/distances from the actual boundary wire 104, while the transmitter 103 emits the containment signal 107 therefrom, for the boundary of each zone of the selected containment profile during the zone distance setting method. The zone distance setting start screen 180 may further provide a timer option 182 that allows the user to select or configure/customize the amount of time that the user will move the receiver unit 118 to the first boundary location/distance from the boundary wire 104 after initiating the zone distance setting method, and after a location/distance setting is set to that of a subsequent correction zone.

After the user initiates the zone distance setting method from the zone distance setting start screen 180, such as selecting a respective icon/button 186 via the input device of the control interface unit 170, the GUI of the control interface unit 170 start a timer count down from the time value selected/configured/customized by the at 212, and the control interface unit 170 may display a corresponding zone boundary setting timer screen at 213 which illustrates the timer, as shown in FIG. 9. The zone boundary setting timer screen 213 may illustrate the timer to indicate the time remaining for the receiver unit 118 (i.e., the user) to reach the physical location of the boundary of the first/initial correction zone. As shown in FIG. 9, after the first timer expires, the application 200 repeats the timer count down at 212, and displays the corresponding zone boundary setting timer screen at 213, for each subsequent zone from the first/initial correction zone to the last escape correction zone located closest to the boundary wire 104 (after which a completion screen may be displayed).

User initiation of the zone distance setting method from the zone distance setting start screen 180 also causes the control interface unit 170 to transmit control signals to the receiver unit 118 (as discussed in detail above) that cause the receiver unit 118 to enter a zone boundary threshold setting mode. In the zone boundary threshold setting mode, at the conclusion of the respective count down timers, the receiver unit 118 measures the RSSI of the current containment signal 107 (as discussed above) being detected/received (assuming it is validated), and records/stores/saves the RSSI and/or uses it to determine or configure a corresponding RSSI threshold for the respective correction zone in the receiver processor 165 of the receiver unit 118 (e.g., in memory or table accessed by the distance extrapolation algorithm 157). It is noted that more than one (e.g., two or more) RSSI measurements may be taken to set a particular RSSI threshold, such as via averaging the RSSI measurements for example.

Accordingly, the timer time selection, the start of the initial timer, and the initiation of the zone boundary threshold setting mode must be transmitted to the receiver unit 118 via respective control signal(s) from the user control interface 170. The zone distance setting method on the user control interface 170 and the zone boundary threshold setting mode of the receiver unit 118 must be substantially synced/coordinated in time. In some embodiments, in the zone boundary threshold setting mode, the receiver unit 118 may be configured to generate at least one of the containment stimuluses (e.g., emit a tone and/or light up and/or vibrate) each time the countdown timer expires and an RSSI is used to configure a corresponding RSSI threshold in the receiver unit 118, such as to alert the user that the boundary/threshold was recorded and the user should begin moving to the next boundary/threshold location. It is noted that if egress and ingress thresholds are used for a particular zone, the zone distance setting method and the zone boundary threshold setting mode may allow the user to similarly set an RSSI threshold or each, or may only set an RSSI threshold for one of the egress or ingress boundaries and automatically calculate the other.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While dimensions and types of materials may be described herein, they are intended to define parameters of some of the various examples, and they are by no means limiting to all examples and are merely exemplary. Many other examples will be apparent to those of skill in the art upon reviewing the above description. The scope of the various examples should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as referee labels, and are not intended to impose numerical, structural or other requirements on their objects.

Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function cavity of further structure. It is to be understood that not necessarily all such objects or advantages described above may be achieved in accordance with any particular example. Thus, for example, those skilled in the art will recognize that the devices, systems and methods described herein may be embodied or carried out in a manner that achieves or optimizes one advantage or group of advantages as taught herein without necessarily achieving other objects or advantages as may be taught or suggested herein.

While the disclosure has been described in detail in connection with only a limited number of examples, it should be readily understood that the disclosure is not limited to such disclosed examples. Rather, this disclosure can be modified to incorporate any number of variations, alterations, substitutions or equivalent arrangements not heretofore described, but which are commensurate with the spirit and scope of the disclosure. Additionally, while various examples have been described, it is to be understood that aspects of the disclosure may include only one example or some of the described examples. Also, while some disclosure are described as having a certain number of elements, it will be understood that the examples can be practiced with less than or greater than the certain number of elements.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

What is claimed is:

1. An electronic animal containment system comprising: a boundary wire bounding a containment area;
a transmitter electrically coupled with said boundary wire, said transmitter generating a containment signal current in said boundary wire that produces a containment signal in the magnetic field emitted from the boundary wire; and
a receiver unit configured to be carried by an animal, detect the containment signal, selectively deliver at least one electrical correction stimulus to the animal, and selectively deliver and at least one non-electrical correction stimulus to the animal,
wherein the receiver unit is configured to extrapolate the position of the receiver unit in relation to the boundary wire by determining digital received signal strength indications (RSSIs) of the received signal strength of the containment signal,
wherein the receiver unit selectively delivers the at least one electrical correction stimulus and/or the at least one non-electrical correction stimulus to the animal based in part on the determined digital RSSIs of the receiver unit and their relation to a plurality of RSSI thresholds,
wherein the receiver unit selectively delivers the at least one electrical correction stimulus and/or the at least one non-electrical correction stimulus to the animal based on the determined digital RSSIs relative to the plurality of RSSI thresholds and at least one additional factor, and
wherein the at least one additional factor comprises a determination that the animal physically turned around subsequent to a delivery of an electrical correction stimulus such that a subsequent at least one electrical correction stimulus and/or at least one non-electrical correction stimulus is not delivered.

2. The system according to claim 1, wherein the plurality of RSSI thresholds correspond to differing containment zones extending differing distances from the boundary wire.

3. The system according to claim 2, wherein the receiver is configured to deliver differing correction schemes of differing stimuluses when the receiver unit is positioned within the differing containment zones based on the determined digital RSSIs.

4. The system according to claim 3, wherein the receiver unit is configured to deliver a first correction scheme to the animal when the receiver unit is positioned within a first correction zone based on a determined digital RSSI and a first RSSI threshold that comprises the at least one non-electrical correction stimulus and does not comprise the least one electrical correction stimulus.

5. The system according to claim 4, wherein the receiver unit is configured to deliver a second correction scheme to the animal when the receiver unit is positioned within a second correction zone based on a determined digital RSSI and a second RSSI threshold that comprises the least one electrical correction stimulus, the second correction zone being positioned a lesser distance to the boundary wire than the first correction zone, wherein the second RSSI threshold is greater than the first RSSI threshold.

6. The system according to claim 5, wherein the receiver unit is configured to deliver a third correction scheme to the animal when the receiver unit is positioned within a third correction zone based on a determined digital RSSI and a third RSSI threshold that comprises the least one electrical correction stimulus, the third correction zone being positioned a lesser distance to the boundary wire than the second correction zone, wherein the electrical correction stimulus of the third correction scheme comprises an intensity that is greater than the electrical correction stimulus of the second correction scheme, and wherein the third RSSI threshold is greater than the second RSSI threshold.

7. The system according to claim 2, wherein the plurality of RSSI thresholds are user custom configured RSSI thresholds.

8. The system according to claim 1, wherein the at least one additional factor further comprises the status of timer started from a previous delivery of the at least one electrical correction stimulus such that a subsequent at least one electrical correction stimulus and/or at least one non-electrical correction stimulus is not delivered until after the timer expires.

9. The system according to claim 1, wherein the at least one additional factor comprises a determination that the animal physically turned around subsequent to a delivery of an electrical correction stimulus such that a subsequent at least one electrical correction stimulus and/or at least one non-electrical correction stimulus is not delivered until after a determined digital RSSI is below a safe zone RSSI threshold of the plurality of RSSI thresholds.

10. The system according to claim 1, wherein the receiver unit is configured to not determine the digital RSSIs when the at least one electrical correction stimulus is delivered.

11. The system according to claim 1, wherein the receiver unit is configured to progressively deliver the at least one electrical correction stimulus from a low intensity to a maximum intensity from when a determined digital RSSI meets a first correction RSSI threshold to when a subsequent determined digital RSSI meets a second correction RSSI threshold, the second correction RSSI threshold corresponding to lesser distance to the boundary wire than the first correction RSSI threshold.

12. The system according to claim 1, wherein the at least one additional factor comprises a plurality of increasing determined digital RSSIs followed by a plurality of decreasing determined digital RSSIs.

13. The system according to claim 1, wherein the at least one additional factor further comprises a determination of a digital RSSI above an RSSI threshold associated with at least one correction zone, a determination of plurality of increasing digital RSSIs followed by a plurality of decreasing digital RSSIs, and a determination that a turnaround event associated with the receiver unit has not occurred.

14. The system according to claim 1, wherein a determination that the animal physically turned around comprises analyzing accelerometer data from at least one accelerometer of the receiver unit.

15. The system according to claim 14, wherein a determination that the animal physically turned around comprises a determination of accelerometer data that comprises angular velocity or acceleration values from the at least one accelerometer above a threshold for at least a defined time period.

16. An electronic animal containment system comprising:
a boundary wire bounding a containment area, said boundary wire defining a safe zone within the containment area, at least one warning zone within the containment area and at least one correction zone at least partially within the containment area, the at least one correction zone being positioned closer to the boundary wire that the at least one warning zone;
a transmitter electrically coupled with said boundary wire, said transmitter generating a containment signal current in said boundary wire that produces a containment signal in the magnetic field emitted from the boundary wire; and
a receiver unit configured to be carried by an animal, detect the containment signal, selectively deliver at least one electrical correction stimulus to the animal, and selectively deliver at least one correction stimulus to the animal based position of the receiver unit within the at least one warning zone or the at least one correction zone,
wherein the at least one safe zone, at least one warning zone and the at least one correction zone are positioned at respectively closer distances from the boundary wire, and
wherein the receiver unit is configured to extrapolate the position of the receiver unit within the safe zone, the at least one warning zone or the at least one correction zone by determining digital received signal strength indications (RSSIs) of the received signal strength of the containment signal and their relation to a plurality of user custom configured RSSI thresholds corresponding to the at least one warning zone and the at least one correction zone,
wherein the receiver unit is configured to progressively deliver the at least one electrical correction stimulus from a low intensity to a maximum intensity from when a determined digital RSSI meets a first correction RSSI threshold corresponding to a first boundary of the at least one correction zone to when a subsequent determined digital RSSI meets a second correction RSSI threshold corresponding to a first boundary of the at least one correction zone, the second boundary corresponding to lesser distance to the boundary wire than the first boundary, wherein the receiver unit selectively delivers the at least one electrical correction stimulus and/or the at least one non-electrical correction stimulus to the animal in the at least one warning zone and the at least one correction zone based on the determined digital RSSIs relative to the plurality of RSSI thresholds and at least one additional factor,
wherein the at least one additional factor comprises a determination that the animal physically turned around subsequent to a delivery of an electrical correction stimulus such that a subsequent at least one electrical correction stimulus and/or at least one non-electrical correction stimulus is not delivered.

17. The system according to claim 16, wherein the receiver unit is configured to not determine the digital RSSIs when the at least one electrical correction stimulus is selectively delivered.

18. The system according to claim 16, wherein the at least one additional factor comprises a determination that the animal physically turned around subsequent to a delivery of an electrical correction stimulus such that a subsequent at least one electrical correction stimulus and/or at least one non-electrical correction stimulus is not delivered until after a determined digital RSSI is below a warning zone egress RSSI threshold of the plurality of RSSI thresholds.

19. The system according to claim 16, wherein the at least one additional factor comprises a determination that the animal physically turned around subsequent to a delivery of an electrical correction stimulus such that a subsequent at least one electrical correction stimulus and/or at least one non-electrical correction stimulus is not delivered until after a determined digital RSSI is below a safe zone RSSI threshold of the plurality of RSSI thresholds.

20. The system according to claim 16, wherein the at least one additional factor further comprises a determination of a digital RSSI above an RSSI threshold associated with at least one correction zone, a determination of plurality of increasing digital RSSIs followed by a plurality of decreasing digital RSSIs, and a determination that a turnaround event associated with the receiver unit has not occurred, wherein a determination that a turnaround event associated with the receiver unit has not occurred comprises analyzing accelerometer data from at least one accelerometer of the receiver unit, and wherein analyzing the accelerometer data from at least one accelerometer comprises determining that angular velocity or acceleration values from the at least one accelerometer above a velocity or acceleration threshold for at least a first time period has not occured.
